(19) United States
(12) Patent Application Publication
(10) Pub. No.: US 2010/0307465 A1
(43) Pub. Date: Dec. 9, 2010

(54) Infinitely variable, computer-controlled, positive pressure, electrically driven supercharger to increase fuel economy and performance

(76) Inventor: Ross George Haldeman, Albuquerque, NM (US)

Correspondence Address: Ross George Haldeman, 2829 Las Cruces Rd NE, Albuquerque, NM, 87110, US

(21) Appl. No.: 12/802,348

(22) Filed: Jun. 3, 2010

Related U.S. Application Data
(60) Provisional application No. 61/217,718, filed on Jun. 3, 2009.

(51) Int. Cl. F02B 33/00

(52) U.S. Cl. 123/565

(57) ABSTRACT

The present application relates to a means to control and provide variable intake boost levels to an internal combustion engine through the use of a computer, multiple sensors, a motor controller and an electric motor driving a supercharger. This system will operate on voltages of 120 volts or higher utilizing AC or DC current.

### CROSS REFERENCE TO RELATED APPLICATIONS

THIS APPLICATION CLAIMS THE BENEFIT OF PPA Ser. No. 61/217,718, FILED Jun. 3, 2009 BY THE PRESENT INVENTOR, WHICH IS INCORPORATED BY REFERENCE

### BACKGROUND

### Prior Art

### U.S. Patent Documents

01. U.S. Pat. No. 4,183,216 Jan. 15, 1980 Tanaka, et al.
02. U.S. Pat. No. 4,254,625 Mar. 10, 1981 Bergstedt, et al.
03. U.S. Pat. No. 4,596,225 Jun. 24, 1986 Oonaka, et al.
04. U.S. Pat. No. 4,719,758 Jan. 19, 1988 Sumser
05. U.S. Pat. No. 5,003,957 Apr. 2, 1991 Takeda
06. U.S. Pat. No. 5,119,795 Jun. 9, 1992 Goto, et al.
07. U.S. Pat. No. 5,138,839 Jul. 18, 1992 Hitomic, et al.
08. U.S. Pat. No. 5,904,045 May 18, 1999 Kapich
09. U.S. Pat. No. 6,102,013 Jul. 15, 2000 Lee
10. U.S. Pat. No. 6,308,693 Oct. 30, 2001 Lee
11. U.S. Pat. No. 6,513,484 Feb. 4, 2003 Buckland et al.
12. U.S. Pat. No. 6,968,678 Nov. 29, 2005 Le Leux, et al.
13. U.S. Pat. No. 6,978,764 Dec. 27, 2005 Russell, et al.
14. U.S. Pat. No. 7,047,740 May 23, 2006 Fukasawa, et al.
15. U.S. Pat. No. 7,369,934 May 6, 2008 Chatfield, et al.
16. U.S. Pat. No. 7,404,293 Jul. 29, 2008 Ozawa
17. U.S. Pat. No. 7,694,667 Apr. 3, 2010 Williams, et al.
18. U.S. Pat. No. 5,638,796 Jun. 17, 1997 Adams, III, et al.
19. U.S. Pat. No. 6,328,024 Dec. 11, 2001 Kibort
20. U.S. Pat. No. 6,718,955 Apr. 13, 2004 Knight

### Discussion of Prior Art

In general, people of the world have spent a great deal of time and money in an effort to gain more usable horse power from the engines that serve them. There are two major options to accomplish serious changes. One is to add a turbo charger. A second option is to add a super charger.

There are several issues common to the turbo super charger, here after referred to as a turbo. This is a device that uses the expanded hot exhaust gases in the exhaust manifold to drive a turbine wheel. This turbine wheel is connected by a common shaft to a compressor wheel that resides in the intake side of the engine's plumbing and when driven by the exhaust turbine, compresses the air going into the engine.
1. Variable boost pressure is regulated by variable fuel delivery.
2. This creates the turbo lag, toward which a great deal of inventiveness has been directed to reduce, as seen in prior art #s 04, 11, and 13, referenced above. This boost lag occurs because fuel must first be added to the combustion chamber to increase the heat of the combustion process, which will then drive the turbo faster to increase the compressor wheel speed and increase boost pressure.
3. The exhaust from the engine passes through the turbo in close proximity to the compressor side of the turbo, and heat is transferred from the exhaust side to the compressor side. This heat transfer expands the fresh air entering the engine so that it is not as dense, thus reducing the amount of clean combustible air. There is not a lot than can reasonably be done to prevent this occurrence.
4. The turbo, while using wasted, expanded, and heated gases from the engine, actually creates back pressure against the engine. This condition of compressing the exhaust air to drive the turbo will result in an increase in the exhaust gas temperatures in addition to those created by the combustion process.
5. This exhaust back pressure condition will also cause the engine to retain more of the exhaust heat, since it cannot all freely escape.
6. This exhaust back pressure will reduce the efficiency of the next combustion cycle. This will be due to the fact that more of the exhaust gases remain inside the combustion chamber because the high pressure in the exhaust system prevents them from exhausting completely. There is not a lot that can be done to prevent this in the turbo as we continue to develop higher and higher boost pressures to gain the power and efficiencies we desire.
7. The turbo, because of the plumbing of the exhaust components under the hood, will raise the under-hood temperatures, creating more heat for the engine to displace through the cooling radiator. Better designs and turbo locations can mitigate this situation to some degree.
8. The turbo will generally require some form of boost limiting to keep from over boosting the engine and destroying it as seen in the prior art #s 01, 02, 07, 14, 16 in the above list. This often takes the form of valves in either the intake system to bleed off excessive intake pressures or in the exhaust side to bleed off excessive exhaust pressure to limit the speed of the turbo.

In summary, the turbo charger has a long and varied past. There are many destroyed engines in its wake. There are also very many great success stories from its more recent past. However, there are five main problems with a turbo charger and all of these, with the possible exception of #4 below, are going to increase as we demand more from them in an effort to reduce fuel consumption and increase air-to-fuel ratios.
1. It causes the engine to retain too much heat.
2. It causes the engine to retain spent exhaust gases into the next combustion cycle.
3. It transfers heat from the exhaust side to the compressor side.
4. It takes complicated valves and moving plates or multiple turbos to help minimize the turbo lag.
5. It cannot create increased boost without increased fuel.

There are also issues common to super chargers as well. This is a device that is driven from an external power source, other than the exhaust, to provide a boost to the air pressure going into the internal combustion engine.
1. Most super chargers are mechanically driven. Some are gear driven and some are belt driven. This ties the super charger rotor speed in a fixed ratio to the speed of the engine. This may limit their boost potential at low engine speeds and may provide too much boost at high engine speeds.
2. Since most super chargers are mechanically driven from the engine, their top end boost at high engine revolutions per minute may require some kind of boost regulator to prevent engine damage as seen in prior art #06.
3. Super chargers cannot respond to increased or decreased loads like a turbo can due to their fixed drive ratio tied to the speed of the engine. This may prevent them from achieving maximum economy due to poor air-to-fuel ratios. See discussion in prior art #08 above.
4. Super chargers can consume unnecessary power to drive them at very low engine speeds and/or during cranking and so some have proposed clutches to disengage them as seen in prior art #s 03, 08, 09.
5. Electrically driven super chargers have been plagued with requiring large amounts of amperage at low voltages to provide a minimal amount of boost. This problem has been shown to some degree in the prior art reference #s 18, 19, 20 included above, where this issue has been demonstrated.

In summary, the mechanically driven super charger has also had a long and varied past. There are many engines destroyed in its wake as well. They are very popular in the drag-racing circuit and they provide an easy installation, for the most part, when compared to a turbo charger. There are five main problems remaining with the super charger of today.
1. Super chargers cannot respond to load changes.
2. Super chargers can over boost at low load conditions occurring at higher engine revolutions per minute.
3. Super chargers cannot develop full boost at low engine revolutions per minute.
4. Mechanically driven super chargers must be able to be mounted in a place to have access to a belt driven from a pulley on the engine crankshaft.
5. Electrically driven super chargers, using today's 12-volt systems, have proven unable to provide enough boost to seriously alter an engine's performance or economy.

### DESCRIPTION

### Field of the Invention

The field of the present invention is the use of an electrically driven super charger whose boost is totally controlled by signals from the computer resulting from analysis of the various sensors it is monitoring. This unit will use voltages of 120 volts or higher, AC or DC, to efficiently deliver the maximum boost required to serve todays and future engine requirements.

### BACKGROUND OF THE INVENTION

My interest in this field began in 1961 when my family's farm in SE Wyoming was beginning to outgrow the machinery commercially available. We began to modify our farm tractors, usually the largest available at the time, by installing turbo chargers on them. This typically resulted in 20% gains in horse power without danger of damaging the engines. There were very few turbo charged engines at this time, and those that existed had serious problems with destroying the engines. It was nothing to see trucks lined up along the road on long hills with oil and antifreeze draining from under the engine onto the roadway.

Over the next several decades, until we sold out after sustaining weather losses too great to overcome, I had perfected a series of changes that I applied to John Deere's largest farm tractor at the time, a 1978 model 8630 4×4. I took the tractor, which was officially rated at 225 power take off horse power, and raised it to 365. This was done solely to pull larger equipment more efficiently. However, one day I discovered that one of the things done to this tractor would turn out to greatly reduce its fuel consumption. This was the use of a turbo charger with a different aspect ratio where the exhaust housing was considerably smaller than normal, which caused the exhaust turbine to spin faster as the exhaust passed through the smaller housing faster. This tractor routinely produced 30 horse power hours per gallon and as much as 37 horse power hours per gallon on lighter loads. The best numbers recorded at that time at the University of Nebraska tractor testing station, a place known and respected all over the world, was a little less than 16 horse power hours per gallon. Because of the many things I had done to this tractor, I was also able to demonstrate that the slower I ran the engine, the more power it developed. When I field tested this tractor, operating it at 1500 revolutions per minute rather than the 2100 as recommended, this smaller turbo, combined with all the things I had learned over those years, allowed this tractor to use an average of 50% less fuel at any heavy load compared to the other two unmodified tractors, which were the same model, pulling the same load at the same speed. It could do this because it ran with 3-5 more pounds of boost compared to the other tractors with the exact same load. I operated this tractor from 1978 through 1988 so I had a long chance to observe what it could do in comparison to the other two tractors just like it.

In about 2004 it occurred to me that there was a better way to accomplish the boost I had done to this tractor, particularly in creating the higher boost levels. Having spent those decades and over 100,000 hours of testing, I knew full well the short comings of the turbo charger. That was when I got the idea to use an electrically driven super charger controlled by a computer. However, when I contacted an engineering friend, I was discouraged by the fact that it would not be possible to deliver the kind of boost I needed using the 12-volt systems. And if I could, it would be very unreliable and would have serious heating problems. So I gave up on the idea for a while.

A little over a year ago, in early 2009, I realized that I would not have to use 12 volts for my idea. I could use higher voltages, such as found on trains and the hybrid vehicles, which led to my Provisional Patent Application a year ago. This regular patent application is the final culmination of all this work over a period of 49 years to date.

### SUMMARY OF THE INVENTION

The one and only major draw back to using the electrically powered super charger does not exist in this application. We know now that we can be using far higher voltages in a vehicle than recently thought by a factor of as much as 20 times or more. The controls to vary the speed of the electric motor driving the hybrid vehicle under battery power have been proven, as of course they have also been proven for decades on all the trains that travel across America. The voltage will be high enough that cables to transfer the power will be small enough to cause no problems. The high voltage generators/alternators are efficient enough that their weight is no longer a serious problem and their size is now workable.

This application will offer a super charger that can now respond to any change in load. It won't be spinning fast when it should not. It can even be stopped if that is what is needed. It won't be over boosting and damaging the engine, as sensors can be used to prevent this and as well as other conditions. Unlike the turbo, it can respond to a signal, such as low engine oil level, and save the engine from serious damage. It can provide maximum boost at any time it is desired. It will not create back pressure against the exhaust, causing all the heating and lowered combustion efficiencies as discussed above. It can be mounted anywhere it will work because there is no direct drive. It can be used to create a constant intake manifold pressure against the engine at all times, raising the air-to-fuel ratios to levels not currently in use today, improving fuel mileage and reducing emissions.

The use of this electrically driven super charger will not only provide us with unusually good fuel economy and reduced emissions, but will provide us with vehicles and equipment that have the kind of responsive power not seen on the road today. This application will have a broad appeal to the automotive, transportation, and industrial equipment industries and the people who operate these units. This application will also have vast implications to the future security and financial well being of our country as the engines equipped with this technology, because of their greater fuel efficiencies, will reduce our dependence on foreign oil from countries who wish to cause us great harm.

### BRIEF DESCRIPTION OF THE DRAWING

The features and advantages of this application will become apparent to those skilled in the art from the following diagram and detailed description of the basics of how the computer controlled super charger will operate.

FIG. 1 shows one possible mounting where the super charger is remotely mounted from the engine. Other possible mountings could include inside the vee of a V-6 or V-8, or on the intake side of an inline engine away from the heat of the exhaust. The location of the super charger will not affect its control by the computer. This diagram is not intended to provide every detail possible as it would be too cumbersome to follow. It is intended to show the possibilities of having different randomly selected sensors working together in the scheme of events to control the super charger so the reader who is skilled in the art can appreciate the vast possibilities that exist with this application.

### DETAILED DESCRIPTION OF HOW REPRESENTATIVE INPUTS WORK WITH THE COMPUTER CONTROLLED SUPER CHARGER

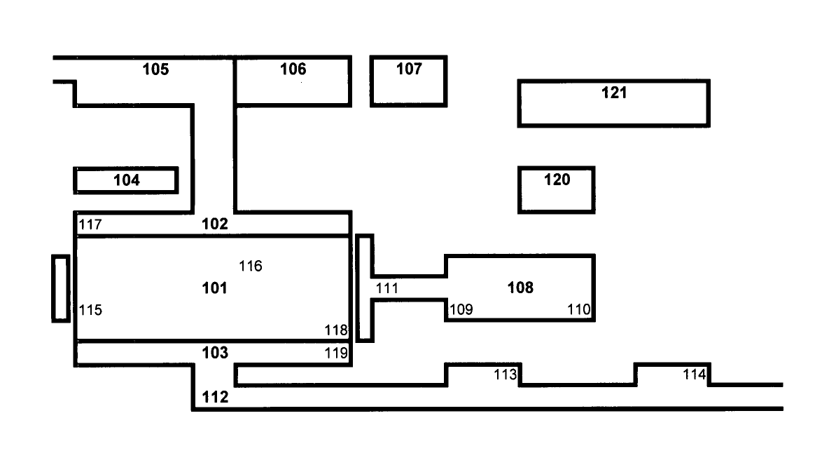

In the layout depicted in FIG. 1 the super charger (105) would come to life after the internal combustion engine (101) has started and the engine rpm sensor (115) is showing idling revolutions. This information fed to the computer (121) will cause the motor controller (107) to set the speed of the super charger motor (106) to match the incoming air so as not to restrict it, nor to create any boost.

When the transmission (108) is placed in gear, this will send a signal from the transmission gear selector sensor (110) to the computer (121) that the transmission is ready as long as the transmission temperature sensor (109) is reading normal values. Now, when the throttle is depressed, this moves the engine throttle position sensor (116), calling for more boost. This signal will be analyzed along with signals from the engine water temperature sensor (118) and the engine exhaust temperature sensor (119). If sensors 118 and 119 have normal readings, the signal is sent to the motor controller (107) to increase the boost. The computer programming and look-up tables will come into play so certain positions on the engine throttle position sensor (116) will convert to certain predetermined super charger motor (106) speeds. Engine (101) revolutions per minute will be measured against the values in the computer program and the look-up tables to determine how little additional fuel will be required to maintain the new desired revolutions.

As the load increases, the engine (101) speed begins to pull down slightly and so the throttle is depressed to regain this lost speed, moving the throttle position sensor (116). This sends a signal to the computer (121) to increase the super charger speed as long as the transmission temperature sensor (109), the engine water temperature sensor (118), the exhaust gas temperature sensor (119), and the intake manifold pressure sensor (117) are all reading normal values. At this point the torque output sensor (111) may come into play as the engine (101) reaches its upper revolutions per minute and call for a transmission (108) up shift. Just prior to shifting up, the transmission gear selector sensor will send a signal to the computer (121) and its programming will call for a brief drop in the speed of the super charger motor (106), facilitating a smoother shift. Once the transmission gear selection sensor (110) determines the transmission has shifted to the next gear, the engine throttle position sensor (116) will call for more boost from the super charger (105), which will react immediately and seamlessly. This will occur as long as the transmission temperature sensor (109), the engine water temperature sensor (118), the exhaust gas temperature sensor (119), and the intake manifold pressure sensor (117) are all reading normal values. If the exhaust gas temperature sensor (119) is reading a value approaching the upper limits, this information will be fed into the computer (121) where it will be analyzed against the values stored there, and the super charger motor (106) will be slowed slightly to reduce boost and to allow the exhaust gas temperature to cool slightly.

Once highway speeds are achieved, the computer (121) will instruct the transmission (108) to select the highest gear. Once the transmission gear selector sensor (110) sees it is in the right gear, this information will be fed back to the computer (121) and the computer (121), using its programming and look-up tables, will determine how to achieve the maximum boost under this light load. At this point the computer (121) will call for the minimum amount of fuel to maintain this low engine speed. This process will provide for maximum air-to-fuel ratios to improve fuel economy and reduce emissions. Note that this process is the opposite of how a turbo works. A turbo in this setting would back off to where the speed would be maintained through supplying enough fuel to keep the turbo spinning fast enough to pull the load. In the application I am sending, the engine (101) will be receiving a predetermined high level of boost and adding just enough fuel to this lean mixture to keep the vehicle running at the desired speed. This application starts with more air, where as the turbo will only work if you start with more fuel.

As we begin to slow down, the computer will be receiving signals from the engine RPM sensor (115) and the transmission gear selector sensor (110) indicating the vehicle is traveling at highway speeds. The computer (121), using the programming and look-up tables, can reverse the super charger electric motor (106) to begin slowing the vehicle through engine braking created by the vacuum between the reversed super charger and the engine.

The above scenario is just an example of how different input sensors can help the electrically driven super charger make the vehicle more responsive and efficient. As mentioned in the claims, there are a lot more sensors that will come into play in the real world today and in the future as the vehicles and equipment of today continue to be improved. Changing the different sensors in the above scenario does not alter the claims being made or the connection between the super charger and the computer.

I claim:

1. An electrically driven, computer-controlled, super charger attached to an internal combustion engine.
a. The boost created from the electrically driven super charger will be controlled by computer inputs fed to the super charger motor controller.
b. The super charger design may be of any type, including but not limited to, the Roots style blower, Paxton and Vortech style of centrifugal design, or radial fan designs. The type used will be determined according to the application and the desired results.
c. The super charger may be integral to the engine design or may be remotely mounted. This is possible because it is not belt or gear driven and will make the unit more usable across a number of different vehicle and equipment configurations.
d. The super charger may be connected to an inter-cooler to lower the temperature of the compressed air to the engine.
e. The computer will utilize specific programming and look-up tables to determine super charger boost levels based on the inputs from various sensors, including but not limited to, monitoring engine water temperature, exhaust gas temperature, engine revolutions per minute, fuel delivery rates, torque output, engine oil levels and/or temperatures, throttle position, intake manifold pressure, knock sensors, transmission temperature, transmission gearing, vehicle speed, traction control. The computer program and table values may be changed to reach the desired results on each application.
f. The electric motor or motors to drive the super charger will operate on voltages above 120 volts, either AC or DC. This will allow for smaller and more efficient components and may create less heat.
g. The electric motor or motors in claim 1.f may be designed as an integral part of the super charger or may drive the super charger through a belt and pulleys, which will allow for more drive ratios to meet a wider range of application. This will also allow a wider range of motor selections for each application.
h. The alternator or generator mounted to the internal combustion engine will be of sufficient capacity and voltage to continuously power the super charger at or near full capacity. This will be important in those situations where the vehicle is in long-term, tough-pulling situations.
i. The alternator or generator in claim 1.h may have additional capacity so as to drive other engine accessories, including but not limited to, the water pump, fan, and hydraulic pump for power steering if used, providing variable speed capabilities not tied to engine speed. This will also allow stopping the fan and hydraulic pump altogether, reducing emissions and fuel consumption.
j. New efficiencies may occur because the electrically powered super charger does away with the pressure in the exhaust manifold required to drive a turbo under load. This will allow for more complete scavenging of exhaust by-products and more complete combustion in the following cycle, requiring less fuel and reducing emissions.
k. The design of claim 1.e will allow the super charger to deliver a continuous minimal boost to the engine, even under light loads, which may allow the computer to deliver the minimum amount of fuel to maintain the desired engine speed, reducing emissions and fuel consumption.
l. The design of claim 1.e will allow the super charger to create enough boost to provide the power needed to operate the engine at slower speeds. Since the speed of the flash point of fuel does not increase as the engine speed does, operating at a lower speed where complete combustion of all the fuel delivered can occur will create better fuel economy and reduced emissions. This is the most significant claim in reducing fuel consumption and reducing emissions. This concept is taken directly from the decades of work from 1961 to the present and more than 100,000 hours of development and testing.
m. The internal combustion engine receiving boost from the electrically powered super charger may operate cooler under loaded conditions as more of the heat generated from the combustion process will escape in the exhaust gases and because there will be less radiant heat around the engine perimeter to be absorbed into the engine when compared to engines getting boost from a turbo with its associated exhaust plumbing and parts.
n. The increased efficiencies and leaner operation may require exhaust treatments such as, but not limited to, the use of a NOₓ scrubber in the exhaust to remove nitrous oxides, a catalytic converter or other designs future technology develops.
o. The design in claim 1.e will provide better drivability with the computer-controlled super charger. Because of the turbo lag, the operator will easily depress the accelerator farther than needed because they don't feel anything happening. Then when the turbo does spool up, it will be going too fast and the boost may be too great for the situation. The computer-controlled super charger will respond instantly to every input and the driver will have instant recognition that the vehicle is responding to his desire to change speed a little. A great example of where this difference will show up is in the stop and go of a traffic jam. It will be too easy to get over boost from a turbo because of the feeling that nothing is happening in that instant, whereas the computer controlled super charger will simply respond to all inputs immediately.
p. The design of claim 1.e and claim 1.o will allow the inputs of safety controls such as traction control signals to be acted on more quickly. If the operator has depressed the accelerator too far in a limited traction situation, the signal from the traction control can shut down the electrically driven super charger the instant wheel slip is recognized. In contrast, the engine equipped with a turbo is receiving too much boost when the wheel starts to slip, based on the excessive accelerator position. Then when the traction control signal shuts down the fuel, the heat will have to dissipate and the exhaust pressure will have to be relieved through the turbo before the turbo can wind down. Because of the over boost from the turbo initially, based on the accelerator position, the wheels will be spinning more at the same point of the wheel slip recognition by the traction control system than with the computer controlled super charger. I recognize this is a very limited amount of time, but anyone who has any experience in poor traction situations knows there is almost never a cushion of time to make a second decision to keep from losing a vehicle if it spins. This seemingly small difference may be what keeps a vehicle from skidding out of control or what makes it possible to extract the vehicle from a bad traction condition. This will also provide greater driver satisfaction.
q. The design of claim 1.e will allow the rotation of the electrically driven super charger to be reversed, creating vacuum and the resulting engine braking. Since this control will be coming from the computer, this engine braking will be fully under the control of such inputs as the traction control system, throttle position sensor, and transmission gear selection sensor. This will reduce brake pad wear and help eliminate the large amounts of brake dust created by the current disc brake setups. In good traction conditions, this engine braking could be all the braking that is needed in most instances.
